(19) United States
(12) Patent Application Publication
(10) Pub. No.: US 2020/0143423 A1
(43) Pub. Date: May 7, 2020

(54) INFORMATION PROCESSING APPARATUS, INFORMATION PROCESSING SYSTEM, AND INFORMATION PROCESSING METHOD

(71) Applicant: TOYOTA JIDOSHA KABUSHIKI KAISHA, Toyota-shi (JP)

(72) Inventors: Tsugumi OTSUKA, Nagoya-shi (JP); Kazuya NISHIMURA, Okazaki-shi (JP); Yuki ITO, Iwakura-shi (JP); Akio UOTANI, Nagoya-shi (JP); Makoto AKAHANE, Nagoya-shi (JP); Wataru SHIINA, Nagoya-shi (JP)

(73) Assignee: TOYOTA JIDOSHA KABUSHIKI KAISHA, Toyota-shi (JP)

(21) Appl. No.: 16/662,269

(22) Filed: Oct. 24, 2019

(30) Foreign Application Priority Data
Nov. 5, 2018 (JP) 2018-208210

(51) Int. Cl. G06Q 30/02; G09F 21/04; G05D 1/02

(52) U.S. Cl. CPC G06Q 30/0266; G05D 1/0287; G09F 21/048

(57) ABSTRACT

An information processing apparatus includes a memory and a processor. The memory holds information about a color representing a vehicle body. The processor determines a first vehicle that is to display first advertising information based on a representative color of the first advertising information and the color representing the vehicle body of each of vehicles, in such a way that the at least one of the first request or the second request is satisfied, and transmits the first advertising information to the first vehicle. The first request is a request for a color representing a vehicle body of a vehicle of which the first advertising information is displayed on a display device installed facing outside. The second request is a request for a representative color of the advertising information to be displayed on the display device of the first vehicle.

### CROSS REFERENCE TO RELATED APPLICATION

This application claims the benefit of Japanese Patent Application No. 2018-208210, filed on Nov. 5, 2018, which is hereby incorporated by reference herein in its entirety.

### BACKGROUND

### Technical Field

The present disclosure relates to an information processing apparatus, an information processing system, and an information processing method.

### Description of the Related Art

There is disclosed a technique of transmitting advertising information regarding an advertisement to a plurality of vehicles that can be present in an area where the advertisement is to be displayed, and of causing an image (video) of the advertisement or a message to be displayed in coordination or in synchronization between vehicle body display units of the vehicles when the vehicles are present in the area where the advertisement is to be displayed (for example, Patent document 1).

### CITATION LIST

### Patent Document

Patent document 1: Japanese Patent Laid-Open No. 2013-089096

An object of an aspect of the disclosure is to provide an information processing apparatus, an information processing system, and an information processing method that are capable of increasing an advertising effect of an advertisement that is displayed on a vehicle body of a vehicle.

### SUMMARY

An aspect of the present disclosure is an information processing apparatus including:

a memory that holds information about a color representing a vehicle body of each of a plurality of vehicles, wherein each of the plurality of vehicles includes a display device installed facing outside the vehicle body and is capable of displaying advertising information on the display device; and

a processor configured to

determine, in a case where there exists at least one of a first request or a second request, a first vehicle that is to display first advertising information, from the plurality of vehicles, on a basis of a representative color of colors included in the first advertising information and the color representing the vehicle body of each of the plurality of vehicles, in such a way that the at least one of the first request or the second request is satisfied, wherein the first request is set in the first advertising information and is a request for a color representing a vehicle body of a vehicle of which the first advertising information is displayed on the display device, and the second request is set in the first vehicle and is a request for a representative color of colors included in the advertising information to be displayed on the display device of the first vehicle, and

transmit the first advertising information to the first vehicle.

An aspect of the present disclosure is an information processing system including:

a memory that holds information about a color representing a vehicle body of each of a plurality of vehicles, wherein each of the plurality of vehicles includes a display device installed facing outside the vehicle body and is capable of displaying advertising information on the display device; and

at least one processor configured to

determine, in a case where there exists at least one of a first request or a second request, a first vehicle that is to display first advertising information, from the plurality of vehicles, on a basis of a representative color of colors included in the first advertising information and the color representing the vehicle body of each of the plurality of vehicles, in such a way that the at least one of the first request or the second request is satisfied, wherein the first request is set in the first advertising information and is a request for a color representing a vehicle body of a vehicle of which the first advertising information is displayed on the display device, and the second request is set in the first vehicle and is a request for a representative color of colors included in the advertising information to be displayed on the display device of the first vehicle, and

transmit the first advertising information to the first vehicle.

An aspect of the present disclosure is an information processing method including:

holding, in a memory, information about a color representing a vehicle body of each of a plurality of vehicles, wherein each of the plurality of vehicles includes a display device installed facing outside the vehicle body and is capable of displaying advertising information on the display device;

determining, in a case where there exists at least one of a first request or a second request, a first vehicle that is to display first advertising information, from the plurality of vehicles, on a basis of a representative color of colors included in the first advertising information and the color representing the vehicle body of each of the plurality of vehicles, in such a way that the at least one of the first request or the second request is satisfied, wherein the first request is set in the first advertising information and is a request for a color representing a vehicle body of a vehicle of which the first advertising information is displayed on the display device, and the second request is set in the first vehicle and is a request for a representative color of colors included in the advertising information to be displayed on the display device of the first vehicle; and

transmitting the first advertising information to the first vehicle.

An aspect of the present disclosure is an information processing apparatus including:

a memory that holds information about a representative color of colors included in advertising information, for each of a plurality of advertising information pieces to be displayed on a vehicle including a display device that is installed facing outside a vehicle body; and

a processor configured to

determine, in a case where there exists at least one of a first request a second request, first advertising information to be displayed by a first vehicle, among the plurality of advertising information pieces, on a basis of a representative color of colors included in each advertising information of the plurality of advertising information pieces and a color representing a vehicle body of the first vehicle, in such a way that the at least one of the first request or the second request is satisfied, wherein the first request is set in the first advertising information and is a request for a color representing a vehicle body of a vehicle of which the first advertising information is displayed on the display device, and the second request is set in the first vehicle and is a request for a representative color of colors included in the advertising information to be displayed on the display device of the first vehicle, and

transmit the first advertising information to the first vehicle.

According to the present disclosure, an advertising effect of an advertisement that is displayed on a vehicle body of a vehicle may be increased.

### BRIEF DESCRIPTION OF DRAWINGS

FIG. 1 is a diagram illustrating an example of a system configuration of an advertisement distribution system according to a first embodiment;

FIG. 2 is a diagram illustrating an example of a hardware configuration of the center server and the in-vehicle device in the advertisement distribution system;

FIG. 3 is a diagram illustrating an example of an external appearance of the vehicle provided with the display device that is installed facing outside the vehicle;

FIG. 4 is a diagram illustrating an example of a functional configuration of the center server and the in-vehicle device in the advertisement distribution system;

FIG. 5 is an example of an advertisement-related information table that is stored in the advertising information DB;

FIG. 6 is an example of a vehicle information table that is stored in the vehicle information DB;

FIG. 7 is an example of a flowchart of a process by the center server; and

FIG. 8 is an example of a flowchart of a process by the center server for a case where an advertisement acquisition request is received from the in-vehicle device.

### DESCRIPTION OF THE EMBODIMENTS

An aspect of the present disclosure is an information processing apparatus including a memory and a processor. The memory may hold information about a color representing a vehicle body of each of a plurality of vehicles each including a display device installed facing outside the vehicle body and each being capable of displaying advertising information on the display device. The processor may be configured to determine, in a case where there exists at least one of a first request regarding a color representing a vehicle body of a first vehicle for displaying first advertising information or a second request related to one or some or all of the plurality of vehicles and regarding a representative color of colors included in the advertising information to be displayed on the display device, the first vehicle that is to display the first advertising information, from the plurality of vehicles, on a basis of a representative color of colors included in the first advertising information and the color representing the vehicle body of each of the plurality of vehicles, in such a way that the at least one of the first request or the second request that exists is satisfied. The processor may also transmit the first advertising information to the first vehicle.

For example, a color representing a vehicle body is a basic color of the vehicle body. For example, in the case where a plurality of colors is present on a vehicle body, the color representing the vehicle body is a color that occupies a largest proportion. However, the color representing a vehicle body is not limited to one color, and may alternatively be a plurality of colors.

For example, in the case where the advertising information is a still image or a moving image, the representative color of colors included in the advertising information is the basic color. For example, the representative color of colors included in the advertising information is, in many cases, an image color of the advertising information itself or a corporate color of a company that is an advertiser. The representative color of colors included in the advertising information is not limited to one color, and may be a plurality of colors.

For example, the first request regarding the color representing the vehicle body of the first vehicle for displaying the first advertising information is at least one of a color, representing a vehicle body, on which an advertiser of the first advertising information desires the first advertising information to be displayed, a color, representing a vehicle body, on which display of the first advertising information is allowed by the advertiser, or a color, representing a vehicle body, on which the advertiser does not wish the first advertising information to be displayed. The color included in the first request may be one color or a plurality of colors.

For example, the second request regarding a representative color of colors included in the advertising information to be displayed on the display device is at least one of a representative color of colors included in the advertising information, display of which on a vehicle is allowed by a user associated with the vehicle, or a representative color of colors included in the advertising information, display of which on the vehicle is rejected by the user. The color included in the second request may be one color or a plurality of colors.

According to an aspect of the present disclosure, the first advertising information is displayed on the display device that is provided facing outside the vehicle body of (1) a vehicle having a vehicle body, a representative color of which satisfies the first request, (2) a vehicle with respect to which the representative color of colors included in the first advertising information satisfies the second request, or (3) a vehicle corresponding to (1) and (2). The first request and the second request are highly likely to be specified aiming at an increased sense of unity between the first advertising information and the vehicle body on which the first advertising information is to be displayed. Therefore, according to one aspect of the present disclosure, a sense of unity between advertising information and the vehicle body of a vehicle that displays the advertising information to outside may be increased, and an advertising effect may be increased.

Furthermore, in one aspect of the present disclosure, the processor of the information processing apparatus may receive position information of a plurality of vehicles. In this case, the processor may determine, as the first vehicle, a vehicle, among the plurality of vehicles, that is capable of arriving at a gathering spot set in the first advertising information at a gathering time set in the first advertising information, and may transmit, together with the first advertising information, a gathering instruction including the gathering time and the gathering spot.

According to an aspect of the disclosure, when the gathering time comes, vehicles for displaying the first advertising information to outside may be gathered at the gathering spot. For example, the first advertising information may thereby be presented to pedestrians or occupants of other vehicles present at the gathering spot several times, and the first advertising information may be caused to appeal to the pedestrians, the occupants of other vehicles and the like. For example, a person who sees a scene of gathering of the vehicles displaying the first advertising information to outside may capture the scene and post a captured image on an SNS or the like, and the advertising effect may be further increased in such a case.

In the following, an embodiment of the present disclosure will be described with reference to the drawings. The configuration of the embodiment described below is an example, and the present disclosure is not limited to the configuration of the embodiment.

### First Embodiment

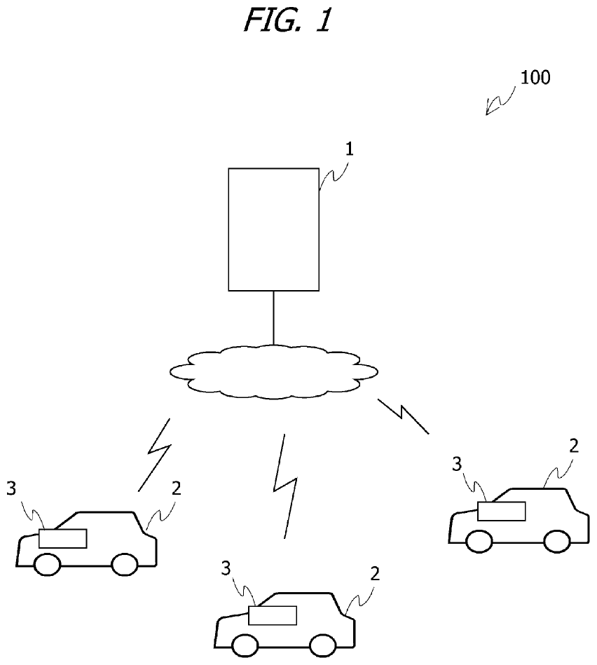

FIG. 1 is a diagram illustrating an example of a system configuration of an advertisement distribution system 100 according to a first embodiment. The advertisement distribution system 100 is a system for displaying advertising information on a display device that is installed facing outside a vehicle, and determines a vehicle for displaying the advertising information, and distributes the advertising information to the determined vehicle. For example, the advertisement distribution system 100 includes a center server 1, and a plurality of in-vehicle devices 3 mounted in a plurality of vehicles 2, respectively.

The center server 1 is connected to a network, such as the Internet, for example. The center server 1 and each in-vehicle device 3 are capable of communicating with each other over the network.

The vehicle 2 is a vehicle provided with a display device that is installed facing outside the vehicle. For example, the vehicle 2 may be a manually driven vehicle or an autonomous vehicle. For example, the in-vehicle device 3 may be any of a data communication device, an in-vehicle device of a car navigation system, or, in the case where the vehicle 2 is an autonomous vehicle, a control device that performs control regarding autonomous driving. Furthermore, the in-vehicle device 3 may be a smartphone, a tablet terminal or the like carried by an occupant of the vehicle 2, for example, as long as there is included a control function for performing display on the display device installed facing outside the vehicle. For example, the in-vehicle device 3 connects to a public network, such as the Internet, by using any of mobile communication such as Long Term Evolution (LTE) or 3G, narrow band communication such as Dedicated Short Range Communications (DSRC), and wireless communication such as WiFi.

For example, in the case where the vehicle 2 is to travel while displaying the advertising information on the display device installed facing outside the vehicle, there is sometimes a demand from the advertiser that the vehicle 2 with a vehicle body of a color that suits an image color of the advertising information is made to display the advertising information. Moreover, there is sometimes a demand from an owner of the vehicle 2 to not display advertising information that does not match the color of the vehicle body of the vehicle 2.

In the first embodiment, the vehicle 2 for displaying the advertising information is determined taking into account the demands from the advertiser and the owner of the vehicle 2 regarding the color of the advertising information and the color of the vehicle 2 for displaying the advertising information. More specifically, in the first embodiment, the center server 1 holds a database of the advertising information, and a database of the vehicle 2 capable of displaying the advertising information. For example, the database of the advertising information holds the image color of the advertising information, specification, by the advertiser, of the color, of the vehicle body, on which the advertising information is desired to be displayed, and the like. For example, the database of the vehicle 2 capable of displaying the advertising information stores the color of the vehicle body, the color, of an advertisement, that is desired by the owner of the vehicle 2 to be displayed, and the like. Specification, by the advertiser, of the color, of the vehicle body, on which the advertising information is desired to be displayed is an example of the “first request”, for example. The color, of an advertisement, that is desired by the owner of the vehicle 2 to be displayed is an example of the “second request”, for example.

The center server 1 selects, as the vehicle 2 for displaying the advertising information, the vehicle 2 that has a vehicle body of a color that is specified by the advertiser as desirable for display of the advertising information, and/or for which the image color of the advertising information is the color desired by the owner.

This may increase the sense of unity between the advertising information and the vehicle 2 that displays the advertising information, and may increase the advertising effect. Because the advertising information, the image color of which is the color desired by the owner of the vehicle 2, may be displayed on the vehicle 2, registration of the vehicle 2 for displaying the advertising information in the advertisement distribution system 100 may be promoted.

Additionally, the image color of the advertising information is specified by the advertiser, for example. The advertising information is created with the image color as the basic color, for example. In the case where the image color is not specified, a color occupying a largest proportion in the advertising information may be taken as the image color, for example.

Additionally, an image color desired not by the owner of the vehicle 2, but by a person who drives the vehicle 2 or an occupant, for example, may also be specified as the image color of the advertising information. The advertising information that is a distribution target is an example of the “first advertising information”. The image color of the advertising information is an example of the “representative color of colors included in the advertising information”. The vehicle 2 for displaying the advertising information that is a distribution target is an example of the “first vehicle”.

Furthermore, in the first embodiment, the center server 1 transmits, together with the advertising information, information about a gathering time and a gathering spot, so as to cause the vehicle 2 for displaying the advertising information to come to a spot specified by the advertiser of the advertising information at a time specified by the advertiser. Accordingly, at the gathering time, the vehicles 2 displaying the same advertising information are gathered at the gathering spot, and the advertising information may be caused to appeal to pedestrians in the surrounding or the media, and the advertising effect may be increased.

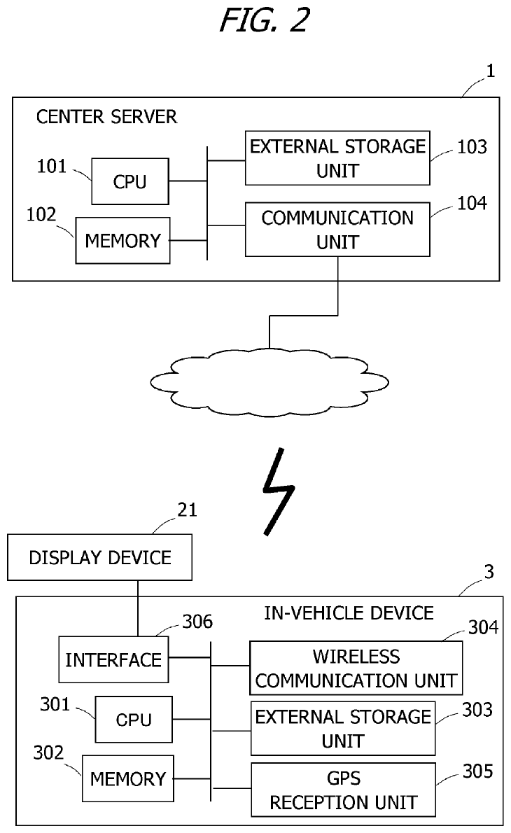

FIG. 2 is a diagram illustrating an example of a hardware configuration of the center server 1 and the in-vehicle device 3 in the advertisement distribution system 100. The center server 1 is a dedicated computer or a general-purpose computer, for example. As hardware components, the center server 1 includes a central processing unit (CPU) 101, a memory 102, an external storage unit 103, and a communication unit 104. The memory 102 and the external storage unit 103 are computer-readable recording media. The center server 1 is an example of the “information processing apparatus”.

The external storage unit 103 stores various programs, and data to be used by the CPU 101 at the time of execution of each program. For example, the external storage unit 103 is an erasable programmable ROM (EPROM) or a hard disk drive. The programs to be held in the external storage unit 103 include an operating system (OS), a control program of the advertisement distribution system 100, and other various application programs, for example. The control program of the advertisement distribution system 100 is a program for selecting the vehicle 2 that is to display the advertising information on the display device facing outside the vehicle, by taking into account the image color of the advertising information and the color of the vehicle body of the vehicle 2, and demands from the advertiser and the owner of the vehicle regarding the colors of the vehicle body and the advertising information, and for distributing the advertising information to the selected vehicle 2. The external storage unit 103 is an example of the “memory”.

The memory 102 is a main memory that provides, to the CPU 101, a storage area and a work area for loading the programs stored in the external storage unit 103, or that is used as a buffer, for example. The memory 102 includes a semiconductor memory such as a read only memory (ROM) and a random access memory (RAM), for example.

The CPU 101 performs various processes by loading, into the memory 102, and executing, the OS and the various application programs that are held in the external storage unit 103. The number of CPUs 101 is not limited to one, and there may be provided a plurality of CPUs 101. The CPU 101 is an example of the “processor” of the “information processing apparatus”.

The communication unit 104 is an interface for performing input/output of information with the network. The communication unit 104 may be an interface that is connected to a wired network, or may be an interface that is connected to a wireless network. For example, the communication unit 104 is a network interface card (NIC) or a wireless circuit. For example, the communication unit 104 connects to a local area network (LAN), and connects to a public network through the LAN, and communicates with various types of servers on the network and the in-vehicle devices 3 through the public communication network.

Now, the in-vehicle device 3 is a data communication device, a car navigation device, or an ETC device, which is mounted in the vehicle 2, for example. The in-vehicle device 3 may alternatively be a smartphone, a tablet terminal or the like carried by an occupant of the vehicle 2, for example, as long as there is included a function for controlling the display device that is installed facing outside the vehicle. Furthermore, in the case where the vehicle is an autonomous vehicle, the in-vehicle device 3 may be a control device for autonomous driving including a communication function for connecting to a public network such as the Internet. Additionally, the in-vehicle device 3 is not limited to the above. Hereinafter, in the first embodiment, a description will be given assuming that the in-vehicle device 3 is a data communication device.

For example, the in-vehicle device 3 includes, as hardware components, a CPU 301, a memory 302, an external storage unit 303, a wireless communication unit 304, a global positioning system (GPS) reception unit 305, and an interface 306. The CPU 301, the memory 302, and the external storage unit 303 are similar to the CPU 101, the memory 102, and the external storage unit 103. However, the external storage unit 303 of the in-vehicle device 3 stores a control program for the in-vehicle device in the advertisement distribution system 100, for example. The control program for the in-vehicle device in the advertisement distribution system 100 is a program for displaying the advertising information received from the center server 1 on the display device that is installed facing outside the vehicle, for example.

For example, the wireless communication unit 304 is a wireless communication circuit for mobile communication such as LTE, LTE-Advanced or 3G, WiFi, or DSRC. Additionally, wireless communication standards for the wireless communication to be performed by the wireless communication unit 304 are not limited to the above. The wireless communication unit 304 connects, by wireless communication, to an access network according to a corresponding wireless communication method, connects to a public network through the access network, and connects to the center server 1 or the like through the pubic network.

The GPS reception unit 305 receives radio waves of time signals from a plurality of satellites orbiting the Earth, and stores the same in a register provided in the CPU 301. For example, the CPU 301 calculates latitude and longitude indicating a position on the Earth on a basis of a detection signal from the GPS reception unit 305, and acquires position information of the vehicle 2 (the in-vehicle device 3).

The interface 306 is an interface for connecting to a display device 21 installed facing outside the vehicle 2, for example. The interface 306 may be directly connected to the display device 21 installed facing outside the vehicle 2 by a cable or the like, or may be connected to a controller area network (CAN) and be connected, through the CAN, to the display device 21 provided facing outside the vehicle 2. The number of display devices 21 installed facing outside the vehicle 2 may be one or more.

Additionally, the hardware configurations of the center server 1 and the in-vehicle device 3 illustrated in FIG. 2 are merely exemplary, and components may be omitted, substituted, or added as appropriate according to the embodiment without being limited to the above description. For example, the center server 1 may include a removable recording medium drive device, and may execute programs recorded in a removable recording medium. For example, the removable recording medium is a recording medium such as an SD card, a mini SD card, a micro SD card, a universal serial bus (USB) flash memory, a compact disc (CD), a digital versatile disc (DVD), a Blu-ray (registered trademark) disc, or a flash memory card. Moreover, the center server 1 may include an input device and an output device, for example. The input device is a keyboard, a mouse, or a touch panel, for example. The output device is a display, for example.

Additionally, series of processes to be performed by the center server 1 and the in-vehicle device 3 are not limited to be performed by execution of software by the CPU 101 or the CPU 301, and may alternatively be performed by hardware such as a field-programmable gate array (FPGA), for example.

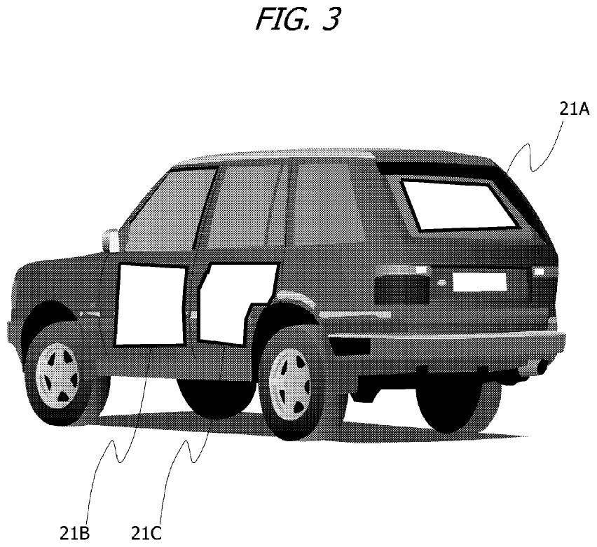

FIG. 3 is a diagram illustrating an example of an external appearance of the vehicle 2 provided with the display device 21 that is installed facing outside the vehicle. For example, the vehicle 2 includes one or a plurality of display devices 21 that are installed facing outside the vehicle. For example, the display device that is installed on the vehicle 2 in a manner facing outside the vehicle is a liquid crystal display, an organic EL display, an LED matrix, a projector, or the like. Furthermore, in the case where a video may be projected on a glass, the display device 21 that is installed on the vehicle 2 in a manner facing outside the vehicle may be a window glass (such as a side window or a rear window), for example.

FIG. 3 illustrates the external appearance of the vehicle 2 seen from a left rear side, and illustrates a display device 21A on a vehicle rear side, a display device 21B installed on a front door on a left side, and a display device 21C installed on a rear door on the left side. The display device 21A on the vehicle rear side may be a rear window, or may be a display installed on a rear inside of the vehicle.

The number of display devices may be different between types or models of the vehicles 2, for example. The display device may be installed at a plurality of positions such as on a left side surface, a right side surface, the vehicle rear side, a vehicle top side, and the like, for example. In the case where a target vehicle is a truck, for example, the display device may be installed at three positions of the left side surface, the right side surface, and the vehicle rear side. In the case where the target vehicle is a sedan, the display devices may be arranged on the left side surface (front door), the left side surface (rear door), the right side surface (front door), and the right side surface (rear door), for example.

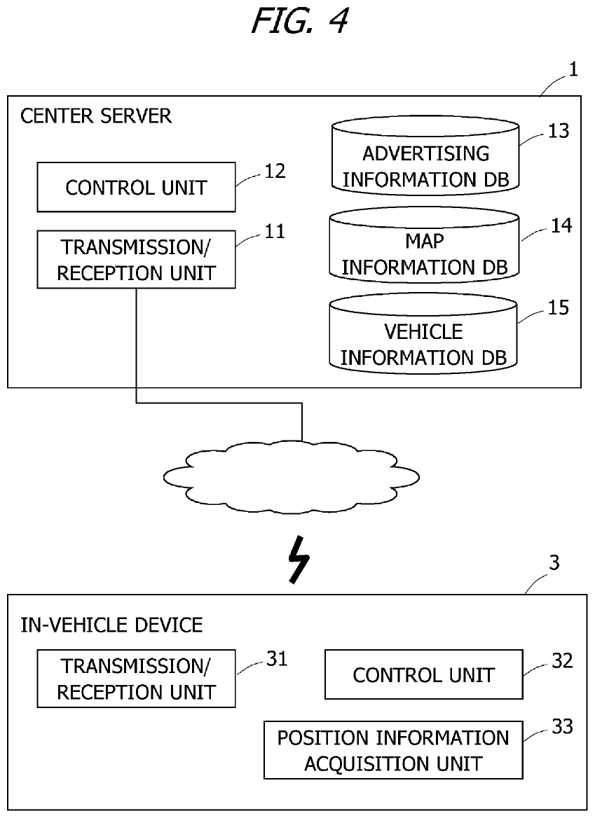

FIG. 4 is a diagram illustrating an example of a functional configuration of the center server 1 and the in-vehicle device 3 in the advertisement distribution system 100. As functional components, the in-vehicle device 3 includes a transmission/reception unit 31, a control unit 32, and a position information acquisition unit 33. These functional components are implemented by the CPU 301 of the in-vehicle device 3 executing the control program for the in-vehicle device in the advertisement distribution system 100 stored in the external storage unit 303, for example.

The transmission/reception unit 31 is an interface for performing communication with the network through the wireless communication unit 304. For example, the transmission/reception unit 31 receives input of position information from the control unit 32 every predetermined period, and transmits the position information to the center server 1 through the wireless communication unit 304. Furthermore, for example, the transmission/reception unit 31 receives the advertising information from the center server 1 through the wireless communication unit 304, and outputs the advertising information to the control unit 32.

For example, the position information acquisition unit 33 acquires, every predetermined period, position information of the vehicle 2 (the in-vehicle device 3) acquired by the GPS reception unit 305 of the in-vehicle device 3, and outputs the position information to the control unit 32. For example, the position information of the vehicle 2 is the latitude and longitude. Alternatively, the position information of the vehicle 2 may be an address. The period at which the position information acquisition unit 33 acquires the position information may be set in a range of 0.1 seconds to 10 seconds, for example, but such a case is not restrictive.

The control unit 32 acquires the position information from the position information acquisition unit 33 every predetermined period, outputs the position information to the transmission/reception unit 31, and transmits the position information to the center server 1 through the transmission/reception unit 31. The period at which the control unit 32 acquires the position information from the position information acquisition unit 33 may be the same as the period at which the position information acquisition unit 33 acquires the position information, or may be a period longer than the period at which the position information acquisition unit 33 acquires the position information, for example.

Furthermore, for example, when an advertisement acquisition request is input from an input device connected to the in-vehicle device 3, by an operation input by an occupant of the vehicle 2, the control unit 32 transmits, to the center server 1, the advertisement acquisition request requesting for the advertising information. The position information of the vehicle 2 is also transmitted together with the advertisement acquisition request.

When input of the advertising information received from the center server 1 is received from the transmission/reception unit 31, the control unit 32 outputs the advertising information to the display device 21, of the vehicle 2, facing outside the vehicle, and causes the display device 21 to display the advertising information. Additionally, in the case where the advertising information includes audio data, the control unit 32 may output the audio data to an external speaker of the vehicle 2.

Furthermore, in the case where information about the gathering spot and the gathering time is received from the center server 1 together with the advertising information, the control unit 32 urges an occupant of the vehicle 2 to drive and arrive at the gathering spot at the gathering time, by outputting and displaying the gathering spot and the gathering time on a display device or the like that is installed facing inside the vehicle 2, for example. However, such a case is not restrictive, and the control unit 32 may create a route for arriving at the gathering spot at the gathering time, for example, and may notify a navigation device of the route, and control the navigation device such that the route is displayed when a departure time on the route is reached. Moreover, in the case where the vehicle 2 is an autonomous vehicle, the control unit 32 may create a route for arriving at the gathering spot at the gathering time, and may control the vehicle 2 such that traveling on the route is started when the departure time on the route is reached, for example.

Next, as functional components, the center server 1 includes a transmission/reception unit 11, a control unit 12, an advertising information DB 13, a map information DB 14, and a vehicle information DB 15. For example, these functional components are implemented by the CPU 101 of the center server 1 executing a control program for the center server 1 in the advertisement distribution system 100 stored in the external storage unit 103.

The transmission/reception unit 11 controls communication with the in-vehicle device 3 performed through the communication unit 104. For example, when the position information is received from the in-vehicle device 3, the transmission/reception unit 11 outputs the position information to the control unit 12. Furthermore, for example, when input of the advertising information is received from the control unit 12, the transmission/reception unit 11 transmits the advertising information to the in-vehicle device 3. Furthermore, when the advertisement acquisition request is received from the in-vehicle device 3, the transmission/reception unit 11 outputs the advertisement acquisition request to the control unit 12.

The control unit 12 receives, from the transmission/reception unit 11, input of the position information received from the in-vehicle device 3. The control unit 12 stores the received position information in the vehicle information DB 15 described later.

For example, when a distribution event for advertising information occurs, the control unit 12 performs a selection process for the vehicle 2 as a distribution destination of the advertising information. The distribution event for the advertising information is reception of input of a distribution request for the advertising information, directly through the input device connected to the center server 1 or over the network, or arrival of a start time, set in advance, for a distribution process for the advertising information, for example.

The control unit 12 refers to the advertising information DB 13 and the vehicle information DB 15, and selects the vehicle 2 as a transmission destination of the advertising information that is a distribution target, in such a way that the color, of the vehicle body, on which the advertising information that is the distribution target is desired by the advertiser to be displayed, and/or the image color, of the advertising information, desired by each vehicle 2 are/is satisfied. Details of the process will be given later.

Furthermore, in the case where the gathering spot and the gathering time are set in the advertising information that is the distribution target, the control unit 12 extracts the vehicle 2 that is present in a range where the gathering spot can be reached at the gathering time, on the basis of the map information DB 14 and the vehicle information DB 15. The range where the gathering spot can be reached at the gathering time is a range of a predetermined distance from the gathering spot, such as a municipality where the gathering spot exists, for example. In the case of a range of a predetermined distance from the gathering spot, the distance may be a fixed value that is set in advance, or may be determined according to a time length from an advertisement distribution time to the gathering time. In the following, the range where the gathering spot can be reached at the gathering time, used for extracting the vehicle 2 will be referred to as an extraction range.

The control unit 12 transmits the advertising information to the in-vehicle device 3 of the vehicle 2 that is selected as the transmission destination of the advertising information. In the case where the gathering spot and the gathering time are set in the advertising information in the advertising information DB 13, information about the gathering spot and the gathering time is also transmitted together with the advertising information. Information including the gathering spot and the gathering time will be hereinafter referred to as gathering information.

Moreover, when the advertisement acquisition request received from the in-vehicle device 3 is received from the transmission/reception unit 11, the control unit 12 selects, from the advertising information DB 13, the advertising information that is to be displayed on the vehicle 2 associated with the in-vehicle device 3, in such a way that the color, of the vehicle body, on which the advertising information that is the distribution target is desired by the advertiser to be displayed and/or the image color, of the advertising information, desired by each vehicle 2 are/is satisfied. Details of the process will be given later. The control unit 12 transmits the selected advertising information to the in-vehicle device 3 as a response to the advertisement acquisition request. In the case where the gathering spot and the gathering time are set in the selected advertising information, the gathering information is also transmitted together with the selected advertising information.

The advertising information DB 13, the map information DB 14, and the vehicle information DB 15 are each created in the storage area of the external storage unit 103 of the center server 1. Map information is stored in the map information DB 14. For example, the map information DB 14 is used at the time of determining the extraction range for extracting the vehicle 2 as the distribution destination of the advertising information that is the distribution target.

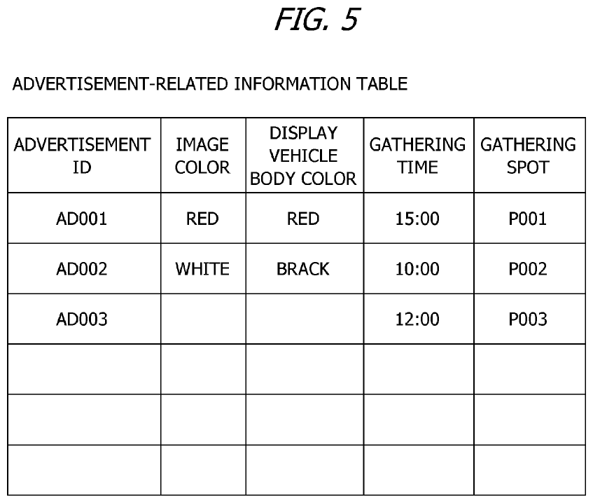

FIG. 5 is an example of an advertisement-related information table that is stored in the advertising information DB 13. The advertisement-related information table storing information related to the advertising information, and the advertising information are stored in the advertising information DB 13. The advertising information is a file such as a still image or a moving image, for example. Additionally, the advertising information may also include audio data. In the example illustrated in FIG. 5, the advertisement-related information table includes fields of an advertisement ID, an image color, a display vehicle body color, a gathering time, and a gathering spot. Information that is held in the advertisement-related information table is an example of “advertisement information”.

In the field of the advertisement ID, identification information of the advertising information is input. In the field of the image color, information about a color as the image color of the advertising information is input. The image color of the advertising information is specified by the advertiser, for example. The advertising information is a still image, a moving image, an illustration, or an animation, for example, and includes a plurality of colors. The image color of the advertising information is the color that is used as the basic color of the advertising information, an image color of a target product of the advertising information, or a corporate color of a company that is the advertiser, for example. In the case where the image color of the advertising information is not specified, the color occupying the largest proportion among the colors included in the advertising information may be input in the field of the image color, for example. The color indicated by the information input in the field of the image color is an example of the “representative color of colors included in the advertising information”.

In the field of the display vehicle body color, information about the color, of the vehicle body, on which the advertising information is desired to be displayed is stored. Information about a plurality of colors may be input in the field of the display vehicle body color. The color indicated by the information input in the field of the display vehicle body color is an example of the “first request”.

In the field of the gathering spot, information about the gathering spot of the vehicle 2 for displaying the advertising information is stored. Information about the gathering spot may be any of latitude and longitude, an address, a name of a building serving as a landmark, and the like, for example. In the field of the gathering time, the gathering time for the vehicle 2 for displaying the advertising information is stored.

Information to be input in each of the fields of the display vehicle body color, the gathering time, and the gathering spot may be specified by the advertiser, for example. Setting of information to be input in each of the fields of the display vehicle body color, the gathering time, and the gathering spot is arbitrary.

Additionally, the information pieces to be held in the advertisement-related information table are not limited to those illustrated in FIG. 5, and may be changed as appropriate according to the embodiment. For example, in the case where a distribution region may be set in the advertising information, information about the distribution region may be held in the advertisement-related information table.

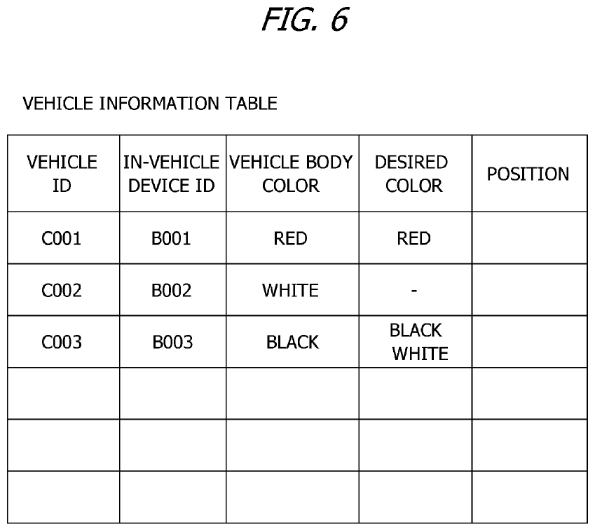

FIG. 6 is an example of a vehicle information table that is stored in the vehicle information DB 15. A vehicle information table holding information about a vehicle is stored in the vehicle information DB 15. In the example illustrated in FIG. 6, the vehicle information table includes fields of a vehicle ID, an in-vehicle device ID, a vehicle body color, a desired color, and a position. The information held in the vehicle information table is an example of “vehicle information”.

In the field of the vehicle ID, identification information of the vehicle 2 is input. For example, as the identification information of the vehicle 2, any of identification information that is uniquely assigned in the advertisement distribution system 100, a vehicle identification number on a license plate, or the like may be used. In the field of the in-vehicle device ID, identification information of the in-vehicle device 3 is input. One or a plurality of in-vehicle devices 3 may be associated with the vehicle 2.

In the field of the vehicle body color, information about the color of the vehicle body of the vehicle 2 is input. In the case where there is a plurality of colors on the vehicle body of the vehicle 2, information about the plurality of colors included on the vehicle body may be input in the field of the vehicle body color, or information about the basic color or the color occupying the largest proportion may be input. The color indicated by the information input in the field of the vehicle body color is an example of the “color representing a vehicle body”. Input is performed in advance in each of the fields of the vehicle ID, the in-vehicle device ID, and the vehicle body color.

In the field of the desired color, information about the image color, of the advertising information, display of which on the display device 21 that is installed facing outside the vehicle 2 is desired by the owner of the vehicle 2, is input, for example. Information about a plurality of colors may be input in the field of the desired color. The information to be input in the field of the desired color may be specified by the owner of the vehicle 2, for example. Moreover, setting of the image color, of the advertising information, display of which on the display device 21 that is installed facing outside the vehicle 2 is desired, is arbitrary, and thus, the field of the desired color is possibly empty. The color indicated by the information input in the field of the desired color is an example of the “second request”.

In the field of the position, the position information of the vehicle 2 is input. The position information is transmitted from the vehicle 2 to the center server 1 every predetermined period, and thus, the field of the position is updated by the control unit 12 every time the position information is received from the vehicle 2.

Additionally, the information pieces to be held in the vehicle information table are not limited to those illustrated in FIG. 6, and may be changed as appropriate according to the embodiment.

The functional configurations of the center server 1 and the in-vehicle device 3 illustrated in FIG. 4 are merely exemplary, and the functional configurations are not limited to those illustrated in FIG. 4.

<Flow of Processes>

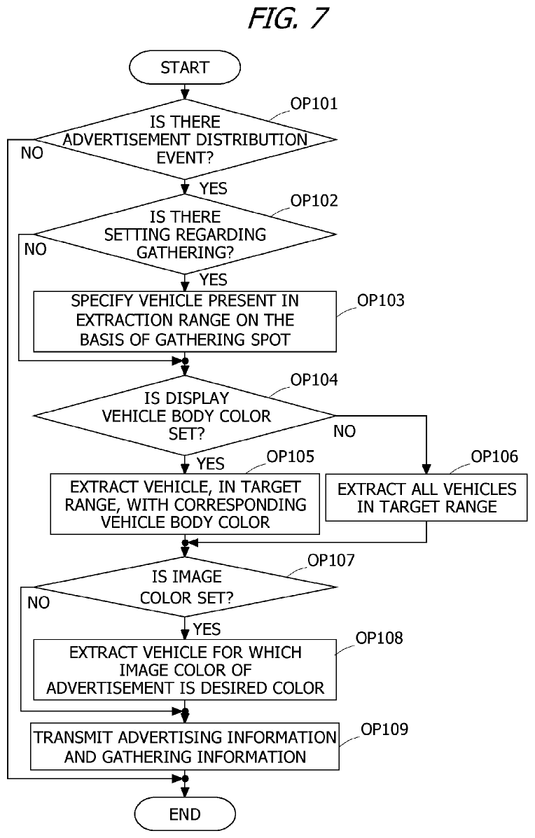

FIG. 7 is an example of a flowchart of a process by the center server 1. The process illustrated in FIG. 7 is repeated every predetermined period, for example. Furthermore, a performer of the process illustrated in FIG. 7 is the CPU 101 of the center server 1, but a description will be given taking a functional component as the performer, for the sake of convenience.

In OP101, the control unit 12 determines whether or not there is occurrence of a distribution event for advertising information. In the case where there is occurrence of a distribution event for advertising information (OP101: YES), the process proceeds to OP102. In the case where there is no occurrence of a distribution event for advertising information (OP101: NO), the process illustrated in FIG. 7 is ended. Advertising information that is a target of a distribution event for advertising information will be hereinafter referred to as target advertising information.

In OP102, the control unit 12 determines whether or not the gathering spot and the gathering time are set in the target advertising information, on the basis of the advertising information DB 13. In the case where the gathering spot and the gathering time are set in the target advertising information (OP102: YES), the process proceeds to OP103. In the case where the gathering spot and the gathering time are not set in the target advertising information (OP102: NO), the process proceeds to OP104.

In OP103, the gathering spot and the gathering time are set in the target advertising information, and thus, the control unit 12 determines the extraction range of the vehicle 2 on the basis of the map information DB 14, and extracts information about the vehicle 2 that is present in the extraction range from the vehicle information DB 15.

In OP104, the control unit 12 determines whether or not the color, of the vehicle body, on which display is desired to be performed is set in the target advertising information, on the basis of the advertising information DB 13. The process in OP104 corresponds to a process of determining whether there is the “first request” or not.

In the case where the color, of the vehicle body, on which display is desired to be performed is set in the target advertising information (OP104: YES), the process proceeds to OP105. In OP105, the control unit 12 extracts, on the basis of the vehicle information DB 15, information about the vehicle 2 that is present in a target range, and the color of the vehicle body of which corresponds to the color, of the vehicle body, on which display of the target advertising information is desired to be performed. The target range in OP105 is the extraction range in OP103 in the case where the process in OP103 is performed, and is a target range of the advertisement distribution system 100 or the distribution region set in the target advertising information in the case where the process in OP103 is not performed.

In the case where the color, of the vehicle body, on which display is desired to be performed is not set in the target advertising information (OP104: NO), the process proceeds to OP106. In OP106, the control unit 12 extracts information about all the vehicles 2 that are present in the target range, on the basis of the vehicle information DB 15. The target range in OP106 is the extraction range in OP103 in the case where the process in OP103 is performed, and is the target range of the advertisement distribution system 100 or the distribution region set in the target advertising information in the case where the process in OP103 is not performed.

In OP107, the control unit 12 determines whether or not the image color is set in the target advertising information, on the basis of the advertising information DB 13. The process in OP107 corresponds to a process of determining whether there is the “second request” or not.

In the case where the image color is set in the target advertising information (OP107: YES), the process proceeds to OP108. In the case where the image color is not set in the target advertising information (OP107: NO), the process proceeds to OP109.

In OP108, the control unit 12 extracts, on the basis of the vehicle information DB 15 and from information pieces about the vehicles 2 extracted prior to the process in OP108, information about the vehicle 2 for which the image color of the target advertising information is the desired color.

In OP109, the control unit 12 transmits, through the transmission/reception unit 11, the target advertising information to the in-vehicle device 3 associated with the vehicle 2 extracted prior to the process in OP109. In the case where there is a setting regarding gathering in the target advertising information, the gathering information is also transmitted. Then, the process illustrated in FIG. 7 is ended. Transmission, in OP109, of the target advertising information to the in-vehicle device 3 is an example of “transmission of a display instruction for the first advertising information to the display device of a first vehicle”. Furthermore, transmission, in OP109, of the gathering information to the in-vehicle device 3, together with the advertising information, is an example of “transmission of a gathering instruction including the gathering time and the gathering spot with a display instruction for the first advertising information”.

Additionally, the process by the center server 1 illustrated in FIG. 7 is merely exemplary, and the process to be performed by the center server 1 is not limited to the process illustrated in FIG. 7. For example, determinations may be performed starting from any of the determinations in OP102, OP104, and OP107. Furthermore, in the example illustrated in FIG. 7, in the case where an affirmative determination is made in OP104, and an affirmative determination is made also in OP107, or in other words, in the case where there are the first request and the second request, the vehicle 2 is selected in such a way as to satisfy the first request and the second request (the vehicle 2 extracted in OP108). However, such a case is not restrictive, and the vehicle 2 may be selected in such a way that one of the first request or the second request is satisfied, even in the case where there are the first request and the second request.

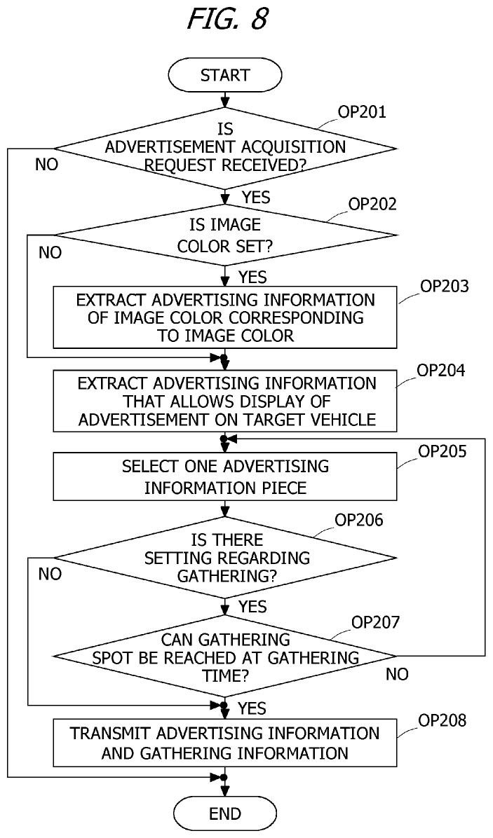

FIG. 8 is an example of a flowchart of a process by the center server 1 for a case where an advertisement acquisition request is received from the in-vehicle device 3. For example, when newly registered in the advertisement distribution system 100, the in-vehicle device 3 transmits, to the center server 1, an acquisition request requesting for advertising information. The position information of the vehicle 2 is also transmitted to the center server 1, together with the advertisement acquisition request. The process illustrated in FIG. 8 is repeated every predetermined period, for example.

In OP201, the control unit 12 determines whether or not an advertisement acquisition request is received from the in-vehicle device 3 through the transmission/reception unit 11. In the case where an advertisement acquisition request is received from the in-vehicle device 3 (OP201: YES), the process proceeds to OP202. In the case where an advertisement acquisition request is not received from the in-vehicle device 3 (OP201: NO), the process illustrated in FIG. 8 is ended. Additionally, the position information of the vehicle 2 is acquired together with the advertisement acquisition request.

In OP202, the control unit 12 refers to the vehicle information DB 15, and determines whether or not an image color, of advertising information, desired to be displayed is set for the target vehicle 2. The process in OP202 corresponds to a process of determining whether there is the “second request” or not.

In the case where an image color, of advertising information, desired to be displayed is set for the target vehicle 2 (OP202: YES), the process proceeds to OP203. In the case where an image color, of advertising information, desired to be displayed is not set for the target vehicle 2 (OP202: NO), the process proceeds to OP204.

In OP203, the control unit 12 extracts, from the advertising information DB 13, advertising information of the image color corresponding to the image color, of advertising information, desired to be displayed set for the target vehicle 2.

In OP204, the control unit 12 extracts, from the advertising information extracted prior to the process in OP204, by referring to the advertising information DB 13, the advertising information that allows to be displayed on the target vehicle 2. For example, the advertising information that allows to be displayed on the target vehicle 2 is the advertising information with respect to which the color, set in the advertising information, of the vehicle body on which display is desired coincides with the color of the vehicle body of the target vehicle 2. For example, advertising information for which the color, of the vehicle body, on which display is desired to be performed is not set may also be included as the advertising information that allows to be displayed on the target vehicle 2. The process in OP204 includes a process of determining whether there is the “first request” or not.

In OP205, the control unit 12 selects one advertising information piece from the advertising information extracted prior to OP205. For example, the control unit 12 may select one advertising information piece randomly or on the basis of a predetermined degree of priority. The predetermined degree of priority is determined on the basis of a degree of priority for the advertiser, or in an order from earliest registration or an order from latest registration, for example. In the following, the advertising information selected in OP205 will be referred to as the target advertising information.

In OP206, the control unit 12 refers to the advertising information DB 13, and determines whether or not the gathering spot and the gathering time are set in the target advertising information. In the case where the gathering spot and the gathering time are set in the target advertising information (OP206: YES), the process proceeds to OP207. In the case where the gathering spot and the gathering time are not set in the target advertising information (OP206: NO), the process proceeds to OP208.

In OP207, the control unit 12 determines whether or not the vehicle 2 may reach the gathering spot at the gathering time in the target advertising information, on the basis of the position information of the vehicle 2. For example, in the case where the vehicle 2 is not present in a range of a predetermined distance from the gathering spot, or in the case where the vehicle 2 is present in a prefecture other than the prefecture where the gathering spot exists, a negative determination is made. In the case where the vehicle 2 may reach the gathering spot at the gathering time in the target advertising information (OP207: YES), the process proceeds to OP208. In the case where the vehicle 2 is not able to reach the gathering spot at the gathering time in the target advertising information (OP208: NO), the process proceeds to OP205, and the target advertising information is newly selected.

In OP208, the control unit 12 transmits the target advertising information to the in-vehicle device 3. In the case where the gathering spot and the gathering time are set in the target advertising information, the gathering information is also transmitted to the in-vehicle device 3, together with the advertising information. Then, the process illustrated in FIG. 8 is ended.

Additionally, the process for the case where the advertisement acquisition request is received from the in-vehicle device 3 is not limited to the process illustrated in FIG. 8. For example, the process in OP204 may be performed before the process in OP202. For example, the advertising information of an image color not corresponding to the image color, of the advertising information, display of which is desired and that is set for the target vehicle 2 may be extracted in OP203, even in the case where an affirmative determination is made in OP202.

### Operation and Effects of First Embodiment

In the first embodiment, advertising information that is a distribution target may be distributed to the vehicle 2 provided with the display device that is installed facing outside the vehicle, in such a way as to satisfy the color, of the vehicle body, on which the advertising information is desired by the advertiser to be displayed and/or the color, of the advertising information, display of which is desired to be performed by the owner of the vehicle 2. Accordingly, for example, the sense of unity between the advertising information and the vehicle body of the vehicle 2 provided with the display device for displaying the advertising information to outside the vehicle may be increased, and the advertising effect may be increased.

Furthermore, in the first embodiment, the vehicles 2 each provided with the display device for displaying the advertising information to outside the vehicle may be gathered at a specified gathering spot at a specified gathering time. Accordingly, for example, the vehicles 2 of the same vehicle body color, displaying the same advertising information to outside the vehicles, may be gathered at the gathering spot. Therefore, for example, the advertising information may be seen more often by pedestrians present at the gathering spot, or an image of such a scene may be posted on SNS or the like, for example, and the advertising effect may be increased.

### Other Embodiments

The embodiment described above is an example, and the present disclosure may be changed and carried out as appropriate without departing from the gist of the present disclosure.

In the first embodiment, the color, of the vehicle body, on which the advertising information is desired by the advertiser to be displayed and/or the color, of the advertising information, desired by the owner of the vehicle 2 to be displayed on the vehicle 2 are/is set, but such a case is not restrictive. For example, the color, of the vehicle body, on which the advertising information is desired by the advertiser not to be displayed and/or the color, of the advertising information, display of which on the vehicle 2 is not desired by the owner of the vehicle 2 may be set, and the corresponding vehicle 2 may be excluded at the time of selecting the vehicle 2 to which the advertising information is to be distributed.

Furthermore, in the first embodiment, when the vehicle 2 to which the advertising information that is the distribution target is to be distributed is selected, the advertising information is transmitted to the selected vehicle 2. Before transmission of the advertising information, a permission for displaying the advertising information may be obtained from the owner of the vehicle 2. In this case, the center server 1 may transmit a display permission request regarding the advertising information, to the in-vehicle device 3 that is associated with the selected vehicle 2. For example, a preview screen of the advertising information, and in the case where there is a setting regarding gathering, the gathering spot and the gathering time are transmitted together with the display permission request. In the case where a display permission message regarding the advertising information is received by the center server 1 from the in-vehicle device 3, the center server 1 may transmit the advertising information that is the distribution target.

Furthermore, the color, of the vehicle body, on which the advertising information is desired to be displayed is not limited to one, and a plurality of colors may be set instead. Moreover, for example, a plurality of colors, and a ratio between the vehicles 2 of respective colors may be set. For example, the vehicles 2 with red vehicle bodies may occupy 90 percent, and the vehicles 2 with green vehicle bodies may occupy 10 percent. The center server 1 may select the vehicles 2 on the basis of such a setting, in a manner satisfying the set ratio between colors.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising:
a memory that holds information about a color representing a vehicle body of each of a plurality of vehicles, wherein each of the plurality of vehicles includes a display device installed facing outside the vehicle body and is capable of displaying advertising information on the display device; and
a processor configured to
determine, in a case where there exists at least one of a first request or a second request, a first vehicle that is to display first advertising information, from the plurality of vehicles, on a basis of a representative color of colors included in the first advertising information and the color representing the vehicle body of each of the plurality of vehicles, in such a way that the at least one of the first request or the second request is satisfied, wherein the first request is set in the first advertising information and is a request for a color representing a vehicle body of a vehicle of which the first advertising information is displayed on the display device, and the second request is set in the first vehicle and is a request for a representative color of colors included in the advertising information to be displayed on the display device of the first vehicle, and
transmit the first advertising information to the first vehicle.

2. The information processing apparatus according to claim 1, wherein the processor is further configured to
receive position information of a vehicle from each of the plurality of vehicles,
determine, as the first vehicle, a vehicle that can reach a gathering spot set in the first advertising information at a gathering time set in the first advertising information, from the plurality of vehicles, and
transmit a gathering instruction including the gathering time and the gathering spot, together with the first advertising information.

3. An information processing method comprising:
holding, in a memory, information about a color representing a vehicle body of each of a plurality of vehicles, wherein each of the plurality of vehicles includes a display device installed facing outside the vehicle body and is capable of displaying advertising information on the display device;
determining, in a case where there exists at least one of a first request or a second request, a first vehicle that is to display first advertising information, from the plurality of vehicles, on a basis of a representative color of colors included in the first advertising information and the color representing the vehicle body of each of the plurality of vehicles, in such a way that the at least one of the first request or the second request is satisfied, wherein the first request is set in the first advertising information and is a request for a color representing a vehicle body of a vehicle of which the first advertising information is displayed on the display device, and the second request is set in the first vehicle and is a request for a representative color of colors included in the advertising information to be displayed on the display device of the first vehicle; and
transmitting the first advertising information to the first vehicle.

4. An information processing apparatus comprising:
a memory that holds information about a representative color of colors included in advertising information, for each of a plurality of advertising information pieces to be displayed on a vehicle including a display device that is installed facing outside a vehicle body; and
a processor configured to
determine, in a case where there exists at least one of a first request a second request, first advertising information to be displayed by a first vehicle, among the plurality of advertising information pieces, on a basis of a representative color of colors included in each advertising information of the plurality of advertising information pieces and a color representing a vehicle body of the first vehicle, in such a way that the at least one of the first request or the second request is satisfied, wherein the first request is set in the first advertising information and is a request for a color representing a vehicle body of a vehicle of which the first advertising information is displayed on the display device, and the second request is set in the first vehicle and is a request for a representative color of colors included in the advertising information to be displayed on the display device of the first vehicle, and
transmit the first advertising information to the first vehicle.
